(19) United States
(12) Patent Application Publication
(10) Pub. No.: US 2026/0014903 A1
(43) Pub. Date: Jan. 15, 2026

(54) SUPPORT ASSEMBLY FOR A VEHICLE

(71) Applicant: Ford Global Technologies, LLC, Dearborn, MI (US)

(72) Inventors: Johnathan Andrew Line, Northville, MI (US); Chuck R. Reese, Whitmore Lake, MI (US); Antonio Martinez Ilescas, Metepec (MX); Jose Maria Aburto, Oaxtepec (MX); Edward Joseph DeSmet, Canton, MI (US); Benjamin Yilma, Canton, MI (US); Sone Sadakhom, Ypsilanti, MI (US); Shawn Anthony Dixon, Windsor (CA); Miguel Angel Carcamo, Mexico City (MX); Jesus Alejo Avila, Mexico City (MX); Chris Fredriksson, LaSalle (CA)

(73) Assignee: Ford Global Technologies, LLC, Dearborn, MI (US)

(21) Appl. No.: 18/767,058

(22) Filed: Jul. 9, 2024

(51) Int. Cl. B60N 2/015; B60N 2/20; B60R 22/18; B62D 25/04

(52) U.S. Cl. CPC B60N 2/015; B60N 2/20; B60R 22/18; B62D 25/04

(57) ABSTRACT

A vehicle includes a first pillar and a second pillar. The first pillar is spaced from and opposite the second pillar to define a gap therebetween. At least one seatback is positioned between the first pillar and the second pillar. A support assembly spans the gap and operably couples the at least one seatback with the first and second pillars. The support assembly includes a first support member operably coupled to the first and second pillars and a second support member telescopically connected with the first support member.

### FIELD OF THE DISCLOSURE

The present disclosure generally relates to a seating assembly for a vehicle, more particularly, to a support assembly extending between the body of the vehicle.

### BACKGROUND OF THE DISCLOSURE

Traditional rear seating solution can be constrained in multifunctionality. There is a need for increased flexibility and functionality in order to optimize user experience.

### SUMMARY OF THE DISCLOSURE

According to one aspect of the present disclosure, a seating assembly for a vehicle includes a first pillar and a second pillar, the first pillar spaced from and opposite the second pillar to define a gap therebetween, at least one seatback positioned between the first pillar and the second pillar, and a support assembly spanning the gap and operably coupling the at least one seatback with the first and second pillars, the support assembly including a first support member operably coupled to the first and second pillars and a second support member telescopically connected with the first support member.

Embodiments of the first aspect of the invention can include any one or a combination of the following features:
at least one seatback is part of a rear seating assembly in a passenger compartment of the vehicle;
the at least one seatback includes a first seatback and a second seatback;
the support assembly is disposed along an upper portion of the first seatback and the second seatback;
a cover overlaying the support assembly, wherein the cover is configured to be flush with the first and second seatback;
a third support member telescopically coupled with the first support member, wherein the second support member and the third support member substantially extend along a length of the first support member;
the second support member aligns with the first seatback and the third support member aligns with the second seatback;
the second and third support member of the support assembly are configured to translate along the length of the first support member;
the second and third support member of the support assembly are rigidly coupled to the first support member;
the second and third support members defines elongate openings positioned at opposing ends of the second and third support member, and wherein the second and third support members are fastened to the first support member at the elongate openings;
the first support member is coaxially nested within the second and third support member of the support assembly;
a plurality of belt loops are disposed along the second and third support members of the support assembly;
the plurality of belt loops align with the first seatback and the second seatback; and
a first bracket operably coupled to the first pillar and a second bracket operably coupled to the second pillar, where the first and second brackets are configured to receive opposing ends of the support assembly.

According to another aspect of the present disclosure, a vehicle includes a body defining a passenger compartment, a first pilar spaced from and opposite a second pillar to define a gap therebetween, a seating assembly disposed in the passenger compartment of the vehicle including at least one seatback positioned between the first pillar and the second pillar, and a support assembly spanning the gap and operably coupling the at least one seatback with the first and second pillars, the support assembly including a first support member and a second support member telescopically connected with the first support member.

Embodiments of the second aspect of the present disclosure can include any one or a combination of the following features:
the at least one seatback includes a first seatback and a second seatback, where the first and second seatbacks are pivotably coupled to a first and second seat base;
the support assembly defines a plurality of apertures, where opposing ends of a plurality of belt loops are disposed in the plurality of apertures; and
the plurality of belt loops are configured to align with the at least one seatback of the seating assembly.

According to another aspect of the present disclosure, a seating assembly for a vehicle includes a vehicle body defining a passenger compartment, a first pillar spaced from and opposite a second pillar to define a gap therebetween, a seating assembly disposed in the passenger compartment of the vehicle including at least one seatback positioned between the first pillar and the second pillar, and a support assembly positioned on a rear side of the passenger compartment spanning the gap and operably coupling the at least one seatback with the first and second pillars, the support assembly including a first support member having opposing ends coupled to the first and second pillars, a second support member telescopically connected with the first support member, and a belt loop assembly disposed along a length of the support assembly.

Embodiments of the third aspect of the present disclosure can include any one or a combination of the following feature:
the belt loop assembly includes a first belt loop configured to align with a first seatback of the seating assembly, a second belt loop configured to align with a first portion of a second seatback, and a third belt loop configured to align with a second portion of the second seatback.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a side perspective view of a vehicle including a seating assembly constructed according to one aspect of the present disclosure;

FIG. 2 is a front plan view of a support assembly coupled to a first pillar and a second pillar of a vehicle body constructed according to one aspect of the present disclosure;

FIG. 3 is a side perspective view of a support assembly including a first, second, and third support member constructed according to one aspect of the present disclosure;

FIG. 4A is a side perspective view of a support member disposed in a bracket coupled to a first pillar of a vehicle constructed according to one aspect of the present disclosure;

FIG. 4B is a side perspective view of a bracket disposed along a height of a first pillar constructed according to one aspect of the present disclosure;

FIG. 5 is a side perspective view of a seating assembly including a support assembly having a plurality of belt loops disposed along a length of the support assembly constructed according to one aspect of the present disclosure;

FIG. 6 is a side perspective view of a rearward portion of a support assembly including a belt loop disposed along a length of the support assembly constructed according to one aspect of the present disclosure;

FIG. 7 is a side perspective view of a seating assembly including headrests constructed according to one aspect of the present disclosure;

FIG. 8 is a rear perspective view of a seating assembly including a ventilation system constructed according to one aspect of the present disclosure;

FIG. 9 is a side perspective view of a seating assembly including a cover constructed according to one aspect of the present disclosure;

FIG. 10 is a side perspective view of a rearward portion of a seating assembly constructed according to one aspect of the present disclosure;

FIG. 11 is a side plan view of a seating assembly including a cover of an upper portion of at least one seatback constructed according to one aspect of the present disclosure;

FIG. 12 is a side perspective view of a seating assembly including framing of at least one seatback constructed according to one aspect of the present disclosure; and

FIG. 13 is a side plan view of a seating assembly including framing of at least one seatback constructed according to one aspect of the present disclosure.

### DETAILED DESCRIPTION OF THE PREFERRED EMBODIMENTS

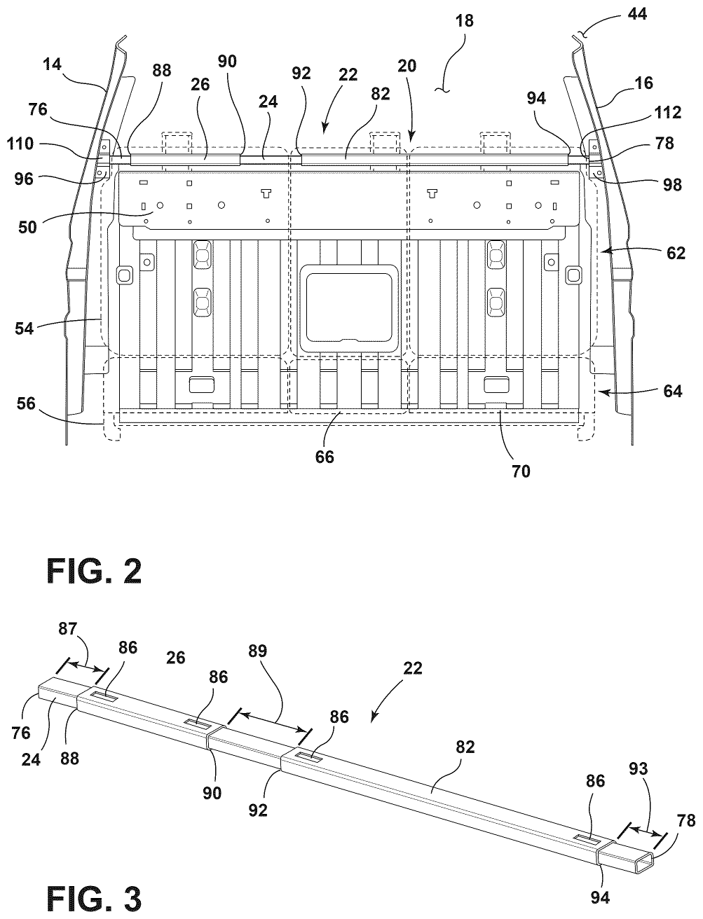

For purposes of description herein, the terms “upper,” “lower,” “right,” “left,” “rear,” “front,” “vertical,” “horizontal,” “interior,” “exterior,” and derivatives thereof shall relate to the device as oriented in FIG. 2. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

Ordinal modifiers (i.e., “first”, “second”, etc.) may be used to distinguish between various structures of the disclosed transportation rack in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

The present illustrated embodiments reside primarily in combinations of method steps and apparatus components related to a seating assembly for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

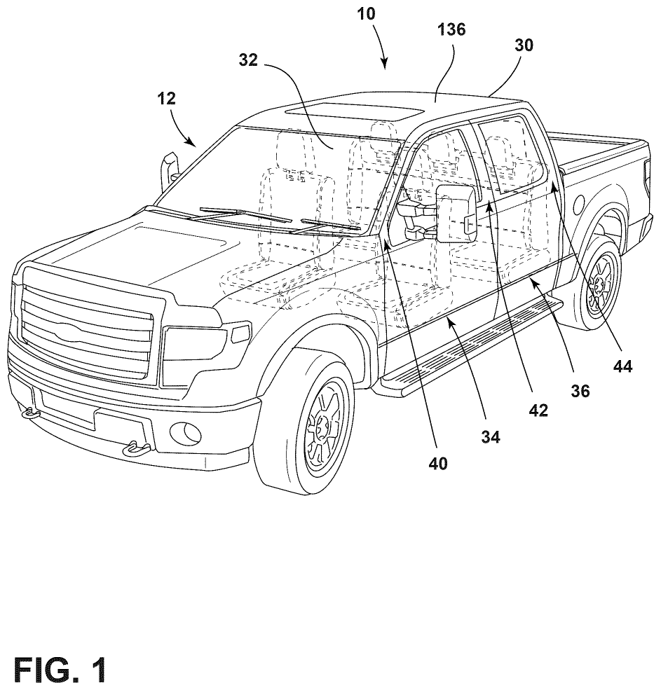

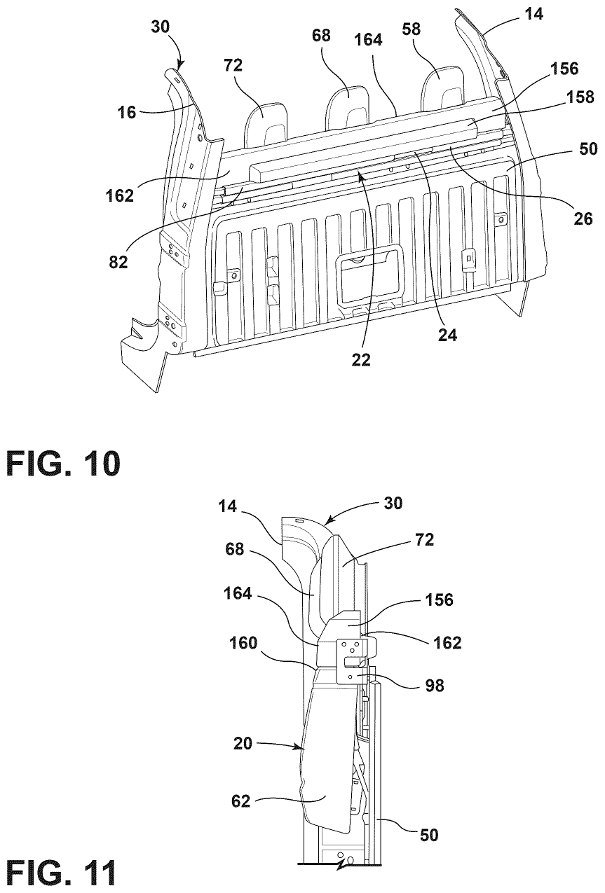

Referring to FIGS. 1-13, a seating assembly is generally designated at 10. In general, the seating assembly 10 for a vehicle 12 can provide for enhanced operability with respect to adjustability by allowing components that are typically coupled to the seating assembly 10 to be offset from the seating assembly 10 in the vehicle 12. The seating assembly 10 can further provide a strong reinforcement structure that can be tailored to the specifications of differing makes and models of the vehicle 12. The seating assembly 10 can also provide for enhanced user experience by providing additional features in the seating assembly 10, such as audio, ventilation, lighting, and storage.

Referring still to FIGS. 1-13, a seating assembly 10 for a vehicle 12 includes a first pillar 14 and a second pillar 16. The first pillar 14 is spaced from and opposite the second pillar 16 to define a gap 18 therebetween. At least one seatback 20 is positioned between the first pillar 14 and the second pillar 16, and a support assembly 22 spans the gap 18 and operably couples the at least one seatback 20 with the first and second pillars 14, 16. The support assembly 22 includes a first support member 24 operably coupled to the first and second pillars 14, 16, and a second support member 26 telescopically connected with the first support member 24.

Referring to FIG. 1, the vehicle 12, such as a wheeled motor vehicle 12, is generally illustrated having a vehicle body 30 defining a cabin interior, also referred to as a passenger compartment 32. The passenger compartment 32 generally includes multiple seating assemblies. The seating assemblies may be arranged in at least one of a first seating row 34 and a second seating row 36. The first seating row 34 is disposed in a vehicle-forward portion of the vehicle 12 and the second seating row 36 is disposed in a vehicle-rearward portion of the vehicle 12. It is contemplated that the seating assemblies may be disposed between the defined seating rows (e.g., the first and second seating rows 34, 36) without departing from the teachings herein. Additionally, it is contemplated that the vehicle 12 may not include the second seating row 36 or may include additional seating rows without departing from the teachings herein.

The vehicle body 30 includes vertical supports, generally referred to as pillars. In the illustrated example depicted in FIG. 1, the pillars include an A-pillar 40, a B-pillar 42, and a C-pillar 44. The first seating row 34 is generally disposed between the A-pillar 40 and the B-pillar 42, while the second seating row 36 is generally disposed between the B-pillar 42 and the C-pillar 44. Additional or fewer pillars may be included in the vehicle 12 without departing from the teachings herein. Additionally, the vehicle 12 is illustrated as a truck, however, the vehicle 12 may be a sedan, sport utility vehicle, a van, a truck, a crossover, or another style vehicle 12. The vehicle 12 may be a manually operated vehicle (e.g., with a human driver), a fully autonomous vehicle (e.g., no human driver), or a partially autonomous vehicle (e.g., may be operated with or without a human driver). The vehicle 12 may be utilized for personal and/or commercial purposes, such as for ride-providing services (e.g., chauffeuring) and/or ride-sharing services.

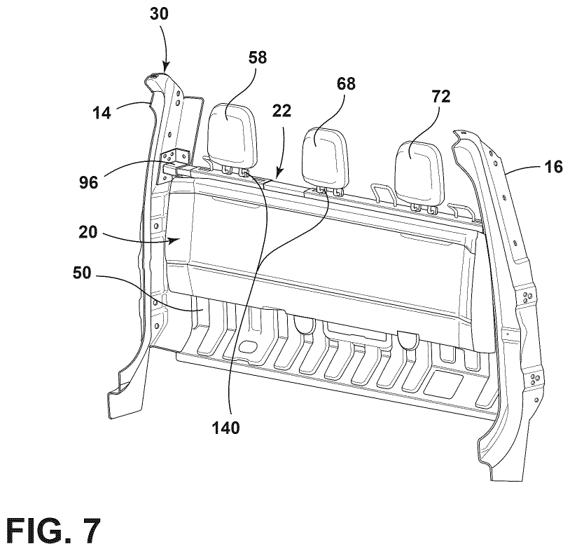

Referring to the illustrated configuration depicted in FIG. 2, the C-pillar 44 includes the first pillar 14 and the second pillar 16 disposed on opposing ends of the second-row seating assembly 36. The first pillar 14 may be spaced apart from the second pillar 16. Accordingly, the first pillar 14 is opposite the second pillar 16 along a vehicle-sideward direction. The first and second pillars 14, 16 may define the gap 18 extending therebetween. In some examples, the seating assembly 10 is a rear seating assembly of the vehicle 12 disposed adjacent to a rear wall 50 of the passenger compartment 32, extending between the first pillar 14 and the second pillar 16 of the C-pillar 44. For example, the second-row seating assembly 36 can include a first seatback 54 coupled to a first seat base 56 having a first headrest 58 (FIG. 7) proximate the first pillar 14. The second-row seating assembly 36 can also include a second seatback 62 coupled to a second seat base 64. The second seatback 62 can include a first portion 66 having a second headrest 68 (FIG. 7) and a second portion 70 having a third headrest 72 (FIG. 7). The first and second portion 66, 70 of the second seatback 62 can be integrally coupled forming a uniform seatback.

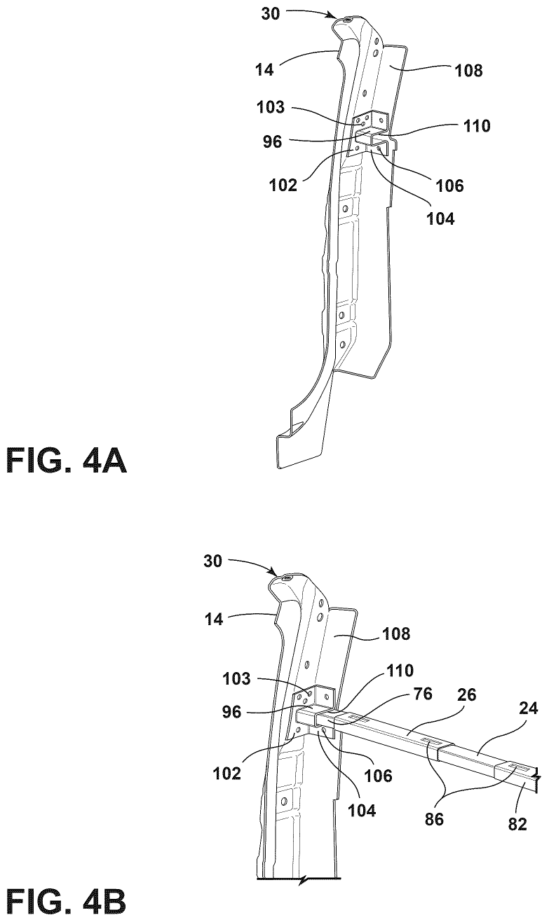

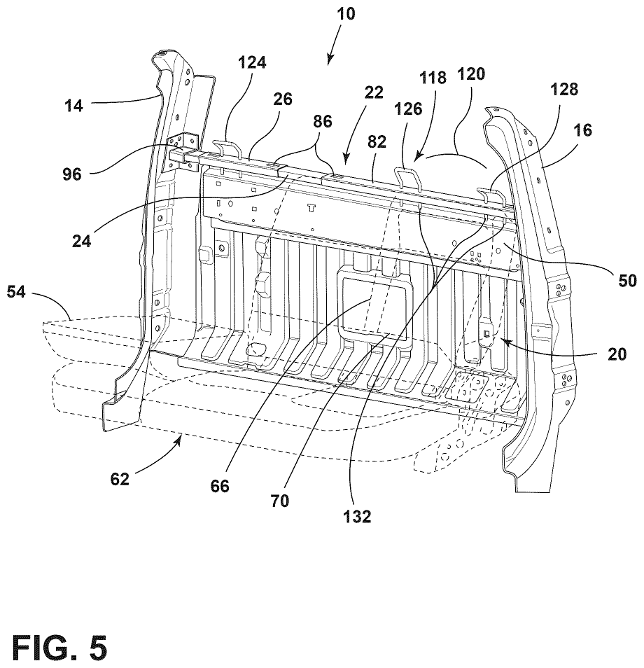

Referring to FIGS. 2 and 3, the support assembly 22 may be coupled to the first and second pillars 14, 16, respectively, and may span the entirety of the gap 18. The support assembly 22 may operably couple the at least one seatback 20 with the first and second pillars 14, 16, as further described herein. The support assembly 22 includes the first support member 24 which may be generally elongated having a generally rectangular cross-section, as shown, however, other shapes may be contemplated. The first support member 24 extends between a first end 76 and a second end 78 configured to operably couple the first and second pillars 14, 16, respectively via a pair of brackets 96, 98 (FIGS. 4A-5). For example, the first end 76 of the first support member 24 may couple the first pillar 14 via one bracket 96 and the second end 78 of the first support member 24 may couple the second pillar 16 via another bracket 98. The first support member 24 may therefore extend between opposing sides of the vehicle body 30 providing additional stiffness and/or rigidity to the vehicle body 30. It is contemplated that the first support member 24 may have a composition including metals such as steel, aluminum, titanium alloys, or other rigid materials such as carbon reinforced polymers, fiberglass reinforced polymers, or high-strength engineering plastics like polyamides.

With continued reference to FIGS. 2 and 3, the support assembly 22 includes at least one outer support member 26 telescopically connected with the first support member 24 that provides one or more connection points for components of the seating assembly 10. For example, the second support member 26 and a third support member 82 may be telescopically connected with the first support member 24, where the second and third support members 26, 82 extend along a length of the first support member 24. The first support member 24 can be coaxially nested within the second and third support members 26, 82, respectively, allowing for the translation and adjustability of the second and third support members 26, 82 relative to the first support member 24 of the support assembly 22. In this way, the connection points can be adjustable based on the size or location of the outer support members 26, 82.

During manufacturing, the outer support members 26, 82 can be positioned on the first support member 24 and translated along the length of the first support member 24 to one or more target locations. For example, the target locations can correspond to positions in which the outer support members 26, 82 allow for seatbelt connections, headrest mounting points or the like. This, based on the size, quantity, and location of the outer support members 26, 82, and the locations of the headrests/seatbelt guides can be selectable for given makes, models or preferences for the vehicle 12.

Still referring to FIGS. 2 and 3, elongated openings 86 can be provided near ends of each outer support member 26, 82 to provide connection points between the first support member 24 and the outer support members 26, 82. During manufacturing, the second and third support members 26, 82 may translate along the length of the first support member 24 to a preferred location on the first support member 24. This telescopic arrangement of the support assembly 22 defines a plurality of slip spaces. A first slip space 87 is defined between the first end 76 of the first support member 24 and a first end 88 of the second support member 26, a second slip space 89 is defined between an opposing second end 90 of the second support member 26 and a first end 92 of the third support member 82, and a third slip space 93 is defined between an opposing second 94 end of the third support member 82 and the second end 78 of the first support member 24. The plurality of slip spaces 87, 89, 93 allows the second and third support members 26, 82 to move and adjust positions relative to the first support member 24, increasing customizability of spacing and positioning of the members of the support assembly 22. Accordingly, the second and third support members 26, 82 can define the slip spaces 87, 89, 93 and can be positioned at preferred locations along the length of the first support member 24. When positioned in the preferred location, the second and third support members 26, 82 may be fastened to the first support member 24 at the elongate openings 86 via welding, bolting, riveting, adhesive bonding, or other suitable fastening mechanisms. For example, the slip spaces 87, 89, 93 may be slot welded at the elongated openings 86. The second and third support members 26, 82 are generally rectangular in shape, however, other shapes may be contemplated.

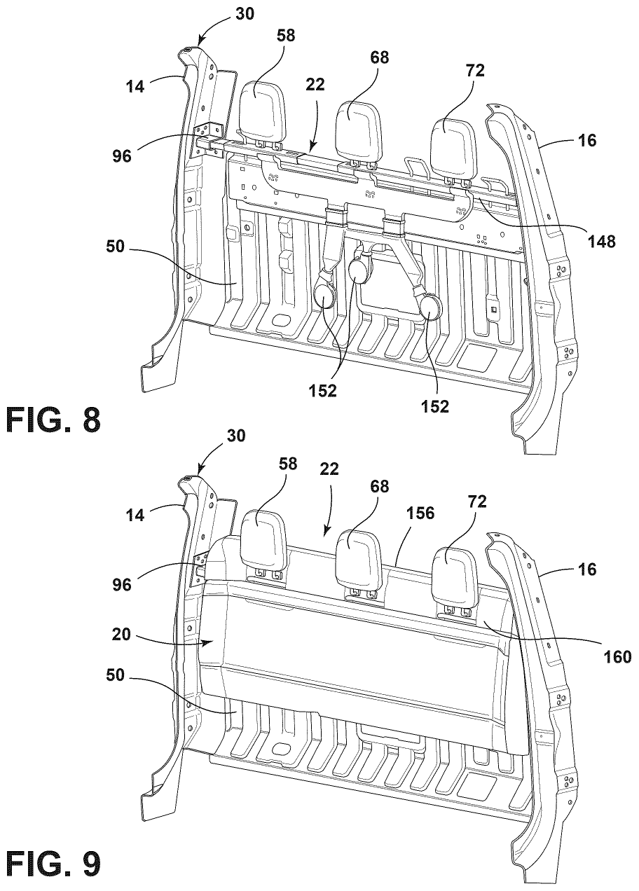

Referring to FIGS. 2-4B, the support assembly 22 is operably coupled to the first and second pillars 14, 16 via a first bracket 96 and a second bracket 98 (FIG. 8), respectively. The first bracket 96 is configured to be secured to the first pillar 14, and the second bracket 98 is configured to be secured to the opposing second pillar 16. Each bracket 96, 98 includes a first plate portion 102 and a second plate portion 104. The second plate 104 portion extends at an angle from the first plate portion 102, such that the plate portions 102, 104 are configured to couple to different parts of the vehicle body 30. For example, when positioned at a target height, the second plate portion 104 can abut a portion of the vehicle body 30 perpendicular to the pillars 14, 16 and be fastened. The fasteners may include, but are not limited to, nails, bolts, threaded inserts, clamps, pins, and so on. It is contemplated that the first and second brackets 96, 98 may be fastened to the first and second pillars 14, 16 using various techniques, such as welding, bolting, or adhesive bonding to rigidly couple the brackets 96, 98 in preferred positions.

The first and second brackets 96, 98 also include a first receiving portion 110 and a second receiving portion 112, respectively. The first receiving portion 110 of the first bracket 96 is configured to receive the first end 76 of the first support member 24 and the second receiving portion 112 of the second bracket 98 is configured to receive the second end 78 of the first support member 24. Accordingly, the first and second receiving portions 110, 112 of the first and second brackets 96, 98 may include channels, slots, tabs, or other features that allow the first and second ends 76, 78 of the first support member 24 to be inserted and retained within the first and second brackets 96, 98. The first and second brackets 96, 98 assist in securing the support assembly 22 across the gap 18 between the first and second pillars 14, 16.

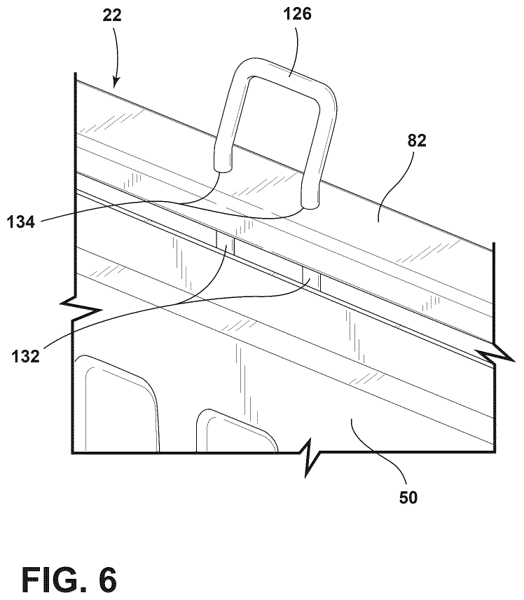

Referring to FIGS. 5 and 6, additional features may be disposed along the length of the support assembly 22. For example, a plurality of belt loops 122, 124, 126 that can be disposed along the support assembly 22. In some examples, the plurality of belt loops 122, 124, 126 include a first belt loop 124 configured to align with the first seatback 54, a second belt loop 126 configured to align with the first portion 66 of the second seatback 62, and a third belt loop 128 configured to align with the second portion 70 of the second seatback 62 of the seating assembly 10. Each belt loop 122, 124, 126 can protrude upwardly from the support assembly 22 to provide a threading location for a seatbelt above the seating assembly 10. The adjustability and telescopic connectivity between the first support member 24 and the second and third support members 26, 82 allows for alternative positioning of each belt loop 122, 124, 126. For example, the support members 24, 26, 82 may include a plurality of through-hole apertures spaced along the length of the support assembly 22. Upon alignment of the through-hole apertures of the second and third support members 26, 82 relative to the first support member 24, passages through the support assembly 22 can be formed and can be configured to receive ends 132 of the plurality of belt loops. Once the belt loops 122, 124, 126 are positioned in the passages, the belt loops 122, 124, 126 may be fastened to the support assembly 22 via welding, a connection-interface fit, snap-in design, slide-in tracks, or other fastening mechanism.

Referring to FIG. 7, the support assembly 22 is configured to provide mounting points for headrests. The headrests can be horizontally mounted into the support assembly 22 to allow space-effective installation/deinstallation of the headrests. In other examples, the headrests can be installed vertically. Headrest brackets 140 can be spaced along the length of the support assembly 22 proximate the plurality of belt loops. The headrest brackets 140 are configured to be coupled to the second and third support members 26, 82 and can protrude upwardly from the second and third support members 26, 82 to provide for mounting locations of the headrests 58, 68, 72 above the support assembly 22. In some examples, the headrest brackets 140 can be configured to receive posts of the headrests 58, 68, 72 vertically or horizontally by slidably engaging with the headrest bracket 140.

Referring to FIG. 8, a ventilation system 144 may be operably coupled to a bottom wall 148 of the support assembly 22. The ventilation system 144 can be configured to provide airflow directly through an upper cushion of the at least one seatback 20 or, in some examples, via dedicated vents corresponding to each seating position (e.g., first and second seatbacks 54, 62). By way of example, the vents can be disposed below each headrests 58, 68, 72 for cooling the occupants below the headrests 58, 68, 72. It is contemplated that, while three blowers 152 are illustrated in FIG. 8, the seating assembly 10 can include any number of blowers 152 for providing airflow to the occupant.

Referring to the illustrated configuration depicted in FIGS. 9-11, the support assembly 22 can also include a cover 156 that is positioned at an upper portion 160 of the seatbacks 54, 62. The cover 156 overlays the first, second, and third support members 24, 26, 82 of the support assembly 22, where the cover 156 is configured to be flush with the first and second seatback 54, 62 to allow for optimal comfort of the occupant, and to provide an aesthetic design to the seating assembly 10. The cover 156 can substantially extend across the length of the support assembly 22 proximate the first and second pillars 14, 16 of the vehicle body 30. The cover 156 can incorporate lighting, audio output, ventilation output, and electrical connectivity that are accessible under or through the cushion. For example, a speaker and/or the electrical outlets may provide electrical power and/or communication to a network (e.g., Universal Serial Bus (USB)) via an electrical outlet. The electrical outlets and/or speakers can be connected to the vehicle audio control via electrical conductors in conduits that extend through the seatbacks 54, 62. For example, conduits having wiring carrying audio signals, control signals, power signals, or other electrical signals can extend through cushion and behind or in a body of the seatbacks 54, 62.

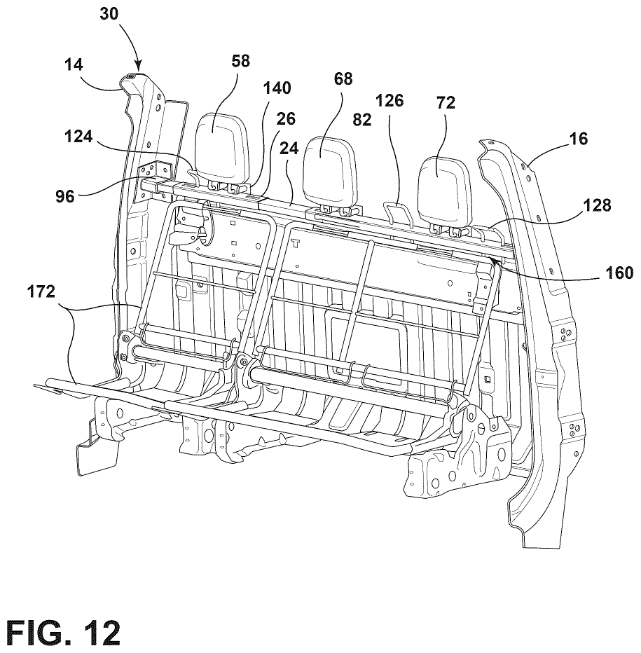

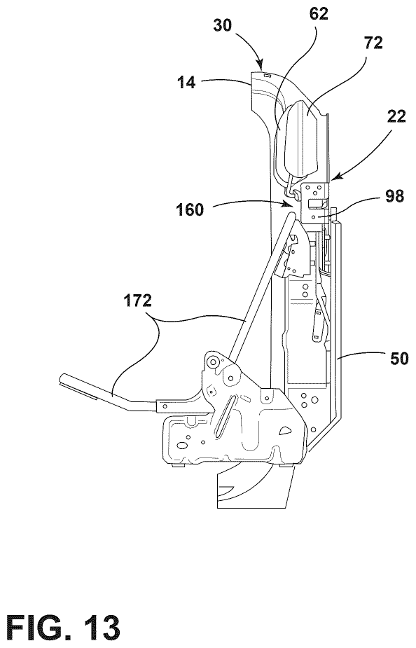

Referring now to FIGS. 12 and 13, the seatbacks 54, 62 are illustrated with outer layers (e.g., the upper cushions and cover 156) removed to demonstrate aspects of the framing 172 and other components under/behind the seatbacks 54, 62. The first and second seatbacks 54, 62 are each pivotable between a use position, as illustrated in FIGS. 12 and 13, in which the seatbacks 54, 62 are adjacent the support assembly 22 and a forward-dumped position in which the first and second seatback 54, 62 have been rotated away from the support assembly 22. Accordingly, as the seatbacks 54, 62 pivot to, from, and between the use position and the forward-dumped position the support assembly 22 remains fixed. In the forward-dumped position, the rear wall 50 is accessible and/or a storage compartment is revealed. The storage compartment can be defined between the rear wall 50 and the seatbacks 54, 62. Thus, the support assembly 22 can provide for a reduction in complexity of the seating assembly 10 by disposing additional components along the first, second, and third support member 24, 26, 82, allowing for the pivotable functionality of the seatbacks 54, 62.

It is to be understood that variations and modifications can be made on the aforementioned structure without departing from the concepts of the present disclosure, and further it is to be understood that such concepts are intended to be covered by the following claims unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A seating assembly for a vehicle, comprising:
a first pillar and a second pillar, the first pillar spaced from and opposite the second pillar to define a gap therebetween;
at least one seatback positioned between the first pillar and the second pillar; and
a support assembly spanning the gap and operably coupling the at least one seatback with the first and second pillars, the support assembly including:
a first support member operably coupled to the first and second pillars; and
a second support member telescopically connected with the first support member.

2. The vehicle of claim 1, wherein the at least one seatback is part of a rear seating assembly in a passenger compartment of the vehicle.

3. The vehicle of claim 1, wherein the at least one seatback includes a first seatback and a second seatback, and wherein the first setback and the second seatback are pivotably coupled to a first seat base and a second seat base.

4. The vehicle of claim 3, wherein the support assembly is disposed along an upper portion of the first seatback and the second seatback.

5. The vehicle of claim 3, further comprising:
a cover overlaying the support assembly, wherein the cover is configured to be flush with the first and second seatback.

6. The vehicle of claim 1, further comprising:
a third support member telescopically coupled with the first support member, wherein the second support member and the third support member extend along a length of the first support member.

7. The vehicle of claim 6, wherein the second support member aligns with the first seatback and the third support member aligns with the second seatback.

8. The vehicle of claim 6, wherein the second and the third support member of the support assembly are configured to translate along the length of the first support member.

9. The vehicle of claim 6, wherein the second and third support members of the support assembly are rigidly coupled to the first support member.

10. The vehicle of claim 6, wherein the second and third support members define elongate openings positioned at opposing ends of the second and third support member, and wherein the second and third support members are fastened to the first support member at the elongate openings.

11. The vehicle of claim 6, wherein the first support member is coaxially nested within the second support member and third support member.

12. The vehicle of claim 6, wherein a plurality of belt loops include a first belt loop coupled to the second support member and a second belt loop coupled to the third support member.

13. The vehicle of claim 12, wherein the first belt loop aligns with an occupant position of the first seatback and the second belt loop aligns with another occupant position of the second seatback.

14. The vehicle of claim 1, further comprising:
a first bracket operably coupled to the first pillar; and
a second bracket operably coupled to the second pillar, wherein the first and second brackets are configured to receive opposing ends of the support assembly.

15. A vehicle, comprising:
a body defining a passenger compartment;
a first pillar spaced from and opposite a second pillar to define a gap therebetween;
a seating assembly disposed in the passenger compartment of the vehicle including at least one seatback positioned between the first pillar and the second pillar; and
a support assembly spanning the gap and operably coupling the at least one seatback with the first and second pillars, the support assembly including a first support member and a second support member telescopically connected with the first support member.

16. The vehicle of claim 15, wherein the at least one seatback includes a first seatback and a second seatback, and wherein the first seatback and the second seatback are pivotably coupled to a first seat base and a second seat base.

17. The vehicle of claim 15, wherein a plurality of belt loops include a first belt loop coupled to the second support member and a second belt loop coupled to a third support member.

18. The vehicle of claim 17, wherein the first belt loop aligns with an occupant position of the first seatback and the second belt loop aligns with another occupant position of the second seatback.

19. A seating assembly for a vehicle, comprising:
a vehicle body defining a passenger compartment;
a first pillar spaced from and opposite a second pillar to define a gap therebetween;
a seating assembly disposed in the passenger compartment of the vehicle including at least one seatback positioned between the first pillar and the second pillar; and
a support assembly positioned on a rear side of the passenger compartment spanning the gap and operably coupling the at least one seatback with the first and second pillars, the support assembly including:
a first support member having opposing ends coupled to the first and second pillars;
a second support member telescopically connected with the first support member, and
a plurality of belt loops distributed along a length of the support assembly.

20. The vehicle of claim 19, further comprising:
a third support member telescopically coupled with the first support member, wherein the second support member and the third support member extend along a length of the first support member.
